(19) United States
(12) Patent Application Publication
(10) Pub. No.: US 2026/0218890 A1
(43) Pub. Date: Jul. 30, 2026

(54) PORTABLE LIGHTING DEVICE WITH A COUPLER ASSEMBLY AND AN ARTICULATION MECHANISM THAT PROVIDES MULTIPLE DEGREES OF FREEDOM AND ADJUSTABILITY

(71) Applicant: Promier Products Inc., Peru, IL (US)

(72) Inventor: Cody Duane Grandadam, Peru, IL (US)

(21) Appl. No.: 19/460,660

(22) Filed: Jan. 27, 2026

Related U.S. Application Data
(60) Provisional application No. 63/750,155, filed on Jan. 27, 2025.

(51) Int. Cl. F21V 23/04; F21V 21/40

(52) U.S. Cl. CPC F21V 23/0414; F21V 21/406

(57) ABSTRACT

The subject matter of this specification can be embodied in, among other things, a portable lighting device that includes a clip assembly configured to secure the portable lighting device to an object, an illumination assembly comprising a housing, at least one light source residing within the housing, a power source residing within the housing and at least one interface that is operably connected to the power source and the at least one light source, and an articulation mechanism having a first end moveably coupled to the illumination assembly and a second end moveably coupled to the clip assembly, wherein the articulation mechanism is configured to provide at least four degrees of freedom and adjustability between the clip assembly and the illumination assembly.

### PRIORITY CLAIM AND CROSS-REFERENCE TO RELATED APPLICATIONS

This application claims priority to U.S. Provisional Patent Application No. 63/750,155, which was filed on Jan. 27, 2025, which application is incorporated in its entirety herein by reference and made a part hereof.

### TECHNICAL FIELD

The present disclosure relates generally to a portable lighting device with a coupler assembly and an integrated articulation mechanism that provides the lighting device with multiple degrees of freedom and adjustability.

### BACKGROUND

Existing lighting products enable a wide range of indoor, outdoor, and nighttime activities. Electronic lighting is typically provided from fixed installations (e.g., a roof, a wall, or ceiling), where a light source receives electrical power from a fixed and wired power source. Such lighting is useful in illuminating a particular area but lacks the flexibility of a portable lighting source. Portable lighting sources, such as flashlights or lanterns, have been developed to provide illumination in varied locations and situations. However, the handheld form-factor of most portable lights makes manual direction easy, but it is generally less useful when hands-free use is required (e.g., cylindrical flashlights roll off-target, lanterns usually have few, if any, fixed angular “stops” to set vertical elevation). Many conventional portable lighting sources are also limited in the number of surfaces or objects they can be affixed to for hands-free use. There is a need for a portable lighting device that can be securely clipped to objects, adhered to planar surfaces, and precisely oriented across multiple axes.

### SUMMARY

The present disclosure provides a portable lighting device with a coupler assembly and an articulation mechanism featuring a polyaxial articulation linkage that provides multiple degrees of freedom and adjustability to facilitate precise directional illumination, as determined by an operator of the portable lighting device, thereby increasing the utility and value of the portable lighting device.

The portable lighting device generally comprises an illumination assembly and a coupler assembly, such as a U-shaped clip assembly, moveably interconnected by the articulation linkage. The articulation linkage is pivotally coupled to the clip assembly at a hinge joint to provide a first degree of freedom (“DOF”) (e.g., vertical tilt) and is polyaxially coupled to the illumination assembly via a ball-and-socket joint to provide three additional degrees of freedom DOF (e.g., pitch, yaw, and roll). In some implementations, the ball-and-socket joint includes a friction-enhancing component, such as a friction cup, configured to maintain the illumination assembly in a selected orientation against gravitational or vibrational forces.

The coupler assembly is configured for multi-modal attachment, utilizing a spring-biased clamping force for primary attachment to objects (e.g., hat brims, straps, or visors) that are inserted into or received by the clip assembly and a secondary attachment mode utilizing a dry-adhesive pad. The dry-adhesive pad may comprise a nanosuction or microsuction material that utilizes mechanical vacuum forces or Van der Waals forces to removably adhere the apparatus to substantially flat, non-porous surfaces. To preserve the longevity of the dry adhesive, the illumination housing may include a standoff ridge configured to maintain a protective air gap between the illumination housing and the adhesive pad when the apparatus is in a folded or closed orientation. This configuration prevents accidental adhesion and compression of the microscopic gaps or crevices within the adhesive material during storage or transport.

In one aspect, a portable lighting device includes a clip assembly configured to secure the portable lighting device to an object, an illumination assembly comprising a housing, at least one light source residing within the housing, a power source residing within the housing and at least one interface that is operably connected to the power source and the at least one light source, and an articulation mechanism having a first end moveably coupled to the illumination assembly and a second end moveably coupled to the clip assembly, wherein the articulation mechanism is configured to provide at least four degrees of freedom and adjustability between the clip assembly and the illumination assembly.

Various embodiments can include some, all, or none of the following features. The first end of the articulation mechanism can be pivotally coupled to one of the clip assembly or the illumination assembly at a hinge joint to provide at least one degree of freedom of movement. The second end of the articulation mechanism can be polyaxially coupled to one of the clip assembly or the illumination assembly at a ball-and-socket joint to provide three degrees of freedom of movement. The ball-and-socket joint can include a ball connector disposed at the first end or the second end of the articulation mechanism, a ball socket defined in the housing of the illumination assembly or the clip assembly, and a friction cup seated within the ball socket and configured to exert a predetermined tension on the ball connector to resist inadvertent movement of the ball connector within the ball socket. The portable lighting device can include an adhesive pad disposed on a surface of the clip assembly. The adhesive pad can be formed of a microsuction material or a nanosuction material. The illumination housing can include a ridge that is received within a channel of the clip assembly to form a standoff between the clip assembly and the illumination housing whereby the illumination housing is prevented from contacting the adhesive pad when the portable lighting device is in a folded configuration. The clip assembly can include a clip base and a spring portion connected at a web, the clip base further comprising at least one flex zone configured to allow the clip base to conform to a surface. The at least one light source can include at least one light emitting diode (LED). The power source can be a rechargeable battery. The illumination assembly can include a secondary illuminator independently controllable from the at least one light source. The secondary illuminator can include an LED light or an electroluminescent (EL) panel light. The housing of the illumination assembly can include at least one seal configured to provide environmental protection for an internal electronic assembly within the housing of the illumination assembly. The housing can include a protective lens, and the illumination assembly can include an internal lens positioned behind the protective lens. The articulation mechanism can be a solid body comprising a hinge barrel at a first end of the solid body and a ball connector at a second end of the solid body opposite the first end, the hinge barrel being secured to the clip assembly by a hinge pin. The illumination assembly can include a user interface comprising at least one of a physical button, a capacitive touch sensor, a toggle switch, or a rotary dial. The illumination assembly can include an electronics assembly configured to cycle the at least one light source through a plurality of operational modes in response to successive actuations of the user interface. The electronics assembly can be configured to detect a predetermined actuation pattern of the user interface to activate a specific operational mode, the predetermined actuation pattern comprising at least one of a long press or a sequence of rapid presses of the user interface.

In another aspect, a portable lighting device includes a clip assembly configured to secure the portable lighting device to an object, the clip assembly having a U-shaped configuration provided by an upper member, a lower member and a curvilinear portion extending between the upper and lower members, the clip assembly also having an adhesive pad disposed on an outer surface of the upper member, an illumination assembly comprising a housing, at least one light source residing within the housing, a power source residing within the housing and at least one interface that is operably connected to the power source and the at least one light source, and an articulation mechanism having a first end moveably coupled to the illumination assembly and a second end moveably coupled to the clip assembly, wherein the articulation mechanism is configured to provide at least four degrees of freedom between the clip assembly and the illumination assembly.

Various embodiments can include some, all, or none of the following features. The housing of the illumination assembly can include a ridge that depends downward from the housing and that is received within a channel of the clip assembly when the portable lighting device is in a folded configuration. Reception of the ridge within the channel can form a standoff between the clip assembly and the housing of the illumination assembly whereby the housing can be prevented from contacting the adhesive pad. The illumination assembly can be pivoted about clip assembly via the articulation mechanism whereby the housing can move away from and expose the adhesive pad such that the portable lighting device can be affixed by the adhesive pad to a support surface.

The integration of a stable, non-cylindrical base of the coupler assembly with a polyaxial articulation mechanism that provides multiple degrees of freedom and adjustability solves the technical problem of light-drift and rolling common in portable lighting, enabling the apparatus to function as a hands-free gaze-aligned light, a stationary lantern, or a surface-mounted task light.

### BRIEF DESCRIPTION OF THE DRAWINGS

The drawing figures depict one or more implementations in accordance with the present teachings by way of example only, not by way of limitation. In the figures, like reference numerals refer to the same or similar elements.

FIG. 1 is a front perspective view of a first embodiment of a portable lighting device.

FIG. 2 is a rear perspective view of the portable lighting device of FIG. 1;

FIG. 3 is an underside perspective view of the portable lighting device of FIG. 1;

FIG. 4 is a left-side view of the portable lighting device of FIG. 1;

FIG. 5A is an underside perspective view of the portable lighting device of FIG. 1;

FIG. 5B is a bottom view of the portable lighting device of FIG. 1;

FIG. 5C is an underside perspective view of the portable lighting device of FIG. 1;

FIG. 5D is an underside perspective view of the portable lighting device of FIG. 1;

FIG. 5E is a rear view of the portable lighting device of FIG. 1;

FIG. 5F is underside perspective view of the portable lighting device of FIG. 1;

FIG. 5G is a left side view of the portable lighting device of FIG. 1;

FIG. 5H is a front view of the portable lighting device of FIG. 1;

FIG. 5I is a right-side view of the portable lighting device of FIG. 1;

FIG. 5J is a top-rear perspective view of the portable lighting device of FIG. 1;

FIG. 5K is a top-rear perspective view of the portable lighting device of FIG. 1;

FIG. 5L is a top-front perspective view of the portable lighting device of FIG. 1;

FIG. 5M is a top view of the portable lighting device of FIG. 1;

FIG. 5N is a top-front perspective view of the portable lighting device of FIG. 1;

FIG. 6 is a front view of the portable lighting device of FIG. 1;

FIG. 7 is a cross-sectional view of the portable lighting device taken along line A-A of FIG. 6;

FIG. 8 is an exploded perspective view of the portable lighting device of FIG. 1;

FIG. 9 is a front perspective view of a second embodiment of the portable lighting device;

FIG. 10 is a second front perspective view of the portable lighting device of FIG. 9;

FIG. 11 is a front view of the portable lighting device of FIG. 9;

FIG. 12 is a rear view of the portable lighting device of FIG. 9;

FIG. 13 is a bottom view of the portable lighting device of FIG. 9;

FIG. 14 is a top view of the portable lighting device of FIG. 9;

FIG. 15 is a left-side view of the portable lighting device of FIG. 9;

FIG. 16 is a right-side view of the portable lighting device of FIG. 9;

FIG. 17 is a top-rear perspective view of the portable lighting device of FIG. 9;

FIG. 18 is a second top-rear perspective view of the portable lighting device of FIG. 9;

FIG. 19 is a bottom-rear perspective view of the portable lighting device of FIG. 9;

FIG. 20 is a second bottom-rear perspective view of the portable lighting device of FIG. 9;

FIG. 21 is a bottom-front perspective view of the portable lighting device of FIG. 9;

FIG. 22 is second bottom-front perspective view of the portable lighting device of FIG. 9;.

FIG. 23 is a rear view of the portable lighting device of FIG. 9;

FIG. 24 is a sectional view of the portable lighting device of FIG. 9, taken along line B-B of FIG. 23;

FIG. 25 is an exploded view of the portable lighting device of FIG. 9;

FIG. 26 is an environmental perspective view showing an exemplary use of the portable lighting device secured to a hat brim for gaze-aligned illumination;

FIG. 27 is an environmental perspective view showing an exemplary use of the portable lighting device resting on a substantially flat support surface, while the portable lighting device is oriented at an operating angle θ to the support surface for illumination purposes;

FIG. 28 is an environmental perspective view showing an exemplary use of the portable lighting device secured to an automotive sun visor, where the portable lighting device is oriented at an operating angle θ to the visor for illumination purposes;

FIG. 29 is an environmental perspective view showing an exemplary use of the portable lighting device removably affixed to an automobile windshield via an adhesive pad, where the portable lighting device is oriented at an operating angle θ to the windshield for illumination purposes;

FIG. 30 is an environmental perspective view showing an exemplary use of the portable lighting device resting on a substantially flat support surface in an inverted base configuration, while the portable lighting device is oriented at an operating angle θ to the support surface for illumination purposes.

### DETAILED DESCRIPTION

In the following detailed description, numerous specific details are set forth by way of examples to provide a thorough understanding of the relevant teachings. However, it should be apparent to those skilled in the art that the present teachings may be practiced without such details. In other instances, well-known methods, procedures, components, and/or circuitry have been described at a relatively high level, without detail, to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified, all without departing from the scope of the disclosed methods and systems. For example, one or more of the following embodiments, part or whole, may be combined, in whole or in part, consistent with the disclosed structures, components and layouts. Accordingly, the drawings detailed description are to be regarded as illustrative in nature, not restrictive or limiting.

### A. Portable Lighting Device 100

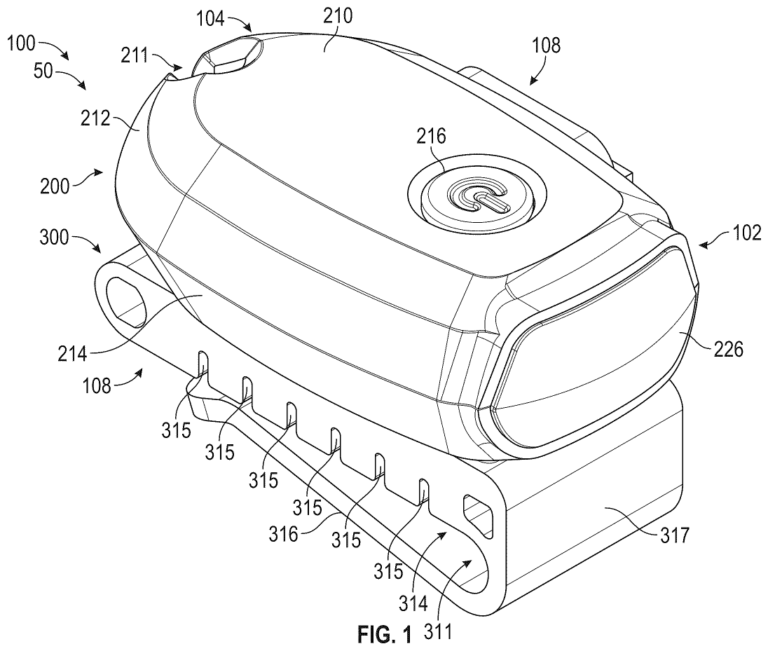

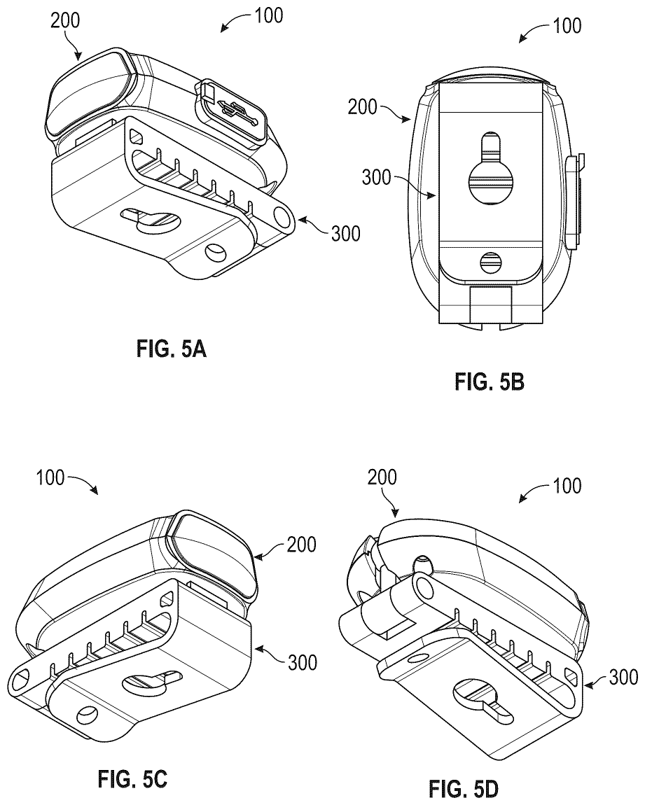

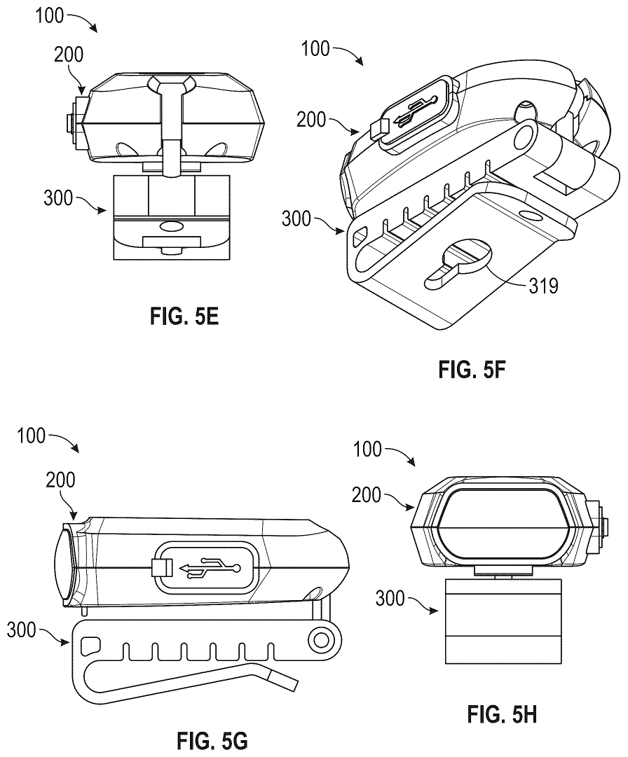

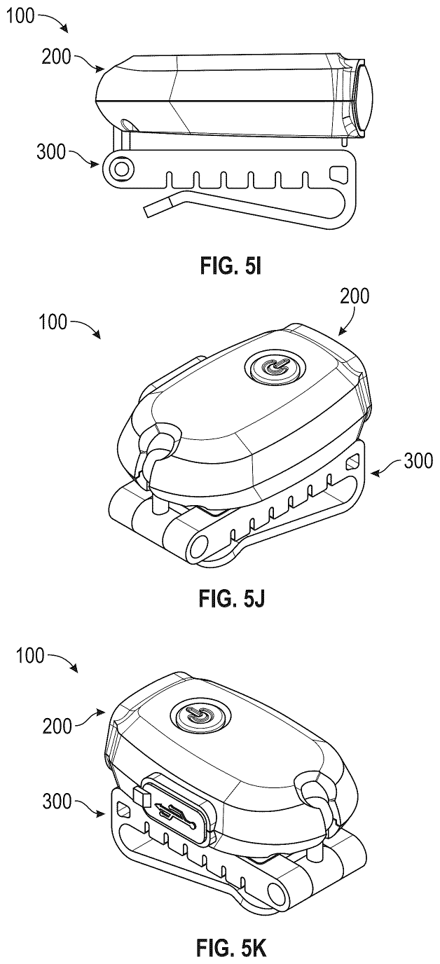

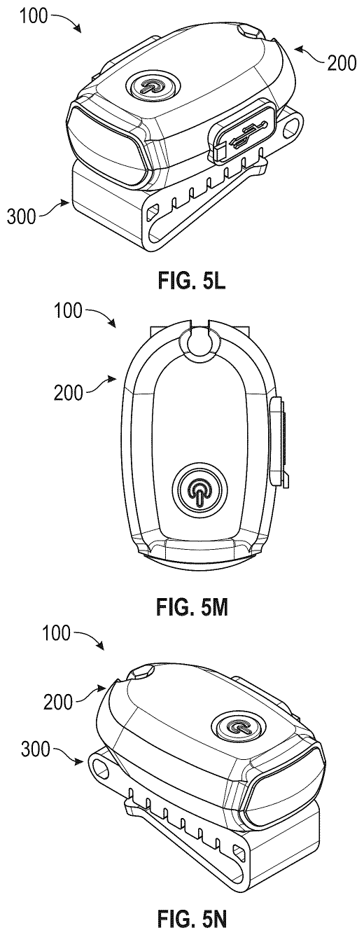

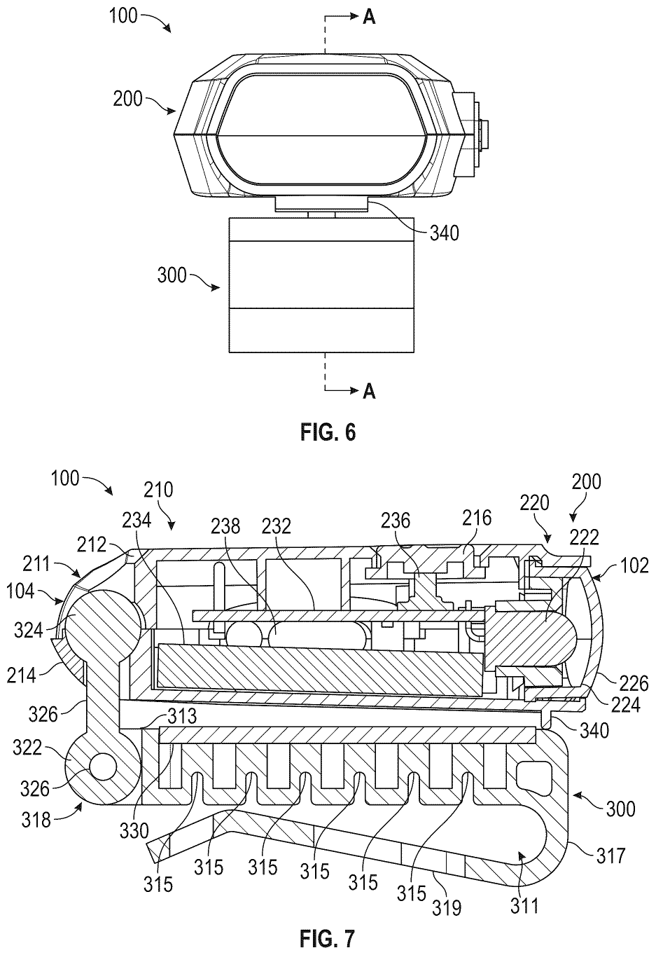

Referring to FIGS. 1-8, a portable lighting device 100 configured as a clip light device 50 is illustrated according to a first embodiment. The portable lighting device 100 generally has an illumination assembly 200 and a clip assembly 300. The illumination assembly 200 and the clip assembly 300 are moveably coupled to one another by an articulation mechanism 320, which is also referred to as an articulation linkage. This configuration allows for the adjustable orientation of light output relative to an object (e.g., a hat, a backpack strap, or a work surface) to which the apparatus 100 is secured. As discussed below, the clip assembly 300 has a U-shaped receiver 311 that receives an object to support the portable lighting device 100, however, the clip assembly 300 can be modified to remove the receiver 311 such that the clip assembly 300 includes a planar support member 313.

The various structural components of the portable lighting device 100 can be constructed from a variety of durable materials. For example, these components can include molded plastics (e.g., ABS, polycarbonate, or polypropylene), metals (e.g., aluminum, titanium, or stainless steel), composite materials (e.g., carbon fiber), or combinations thereof. In some examples, the housing portions can be over-molded with a thermoplastic elastomer (TPE) to improve grip and impact resistance. Additionally, some embodiments of the portable lighting device 100 can include seals and other appropriate components to enable the apparatus 100 to have an Ingress Protection (IP) rating (e.g., IPX4, IP54, IP67) or other form of environmental protection to provide resistance against moisture, dust, and debris.

The illumination assembly 200 (also referred to as a light portion) has an illumination housing 210 that contains an internal illuminator 220 and an electronics assembly 230. The illuminator 220 is an electro-optical circuit and lensing assembly configured to generate and direct light. In one or more embodiments, the housing 210 has an upper housing portion 212 and a bottom or lower housing portion 214. These portions can be secured via fasteners, ultrasonic welding, or snap-fit features to provide the housing 210 with optimized dimensions that allow the portable lighting device 100 to be hand-held and easily stored. As seen in FIG. 1, the housing 210 defines a front 102, a back 104, and lateral sides 106, 108. In some embodiments, the housing 210 may be designed to meet or exceed waterproof standards (e.g., ip67 or ip68) for flashlights and/or designed to float in water.

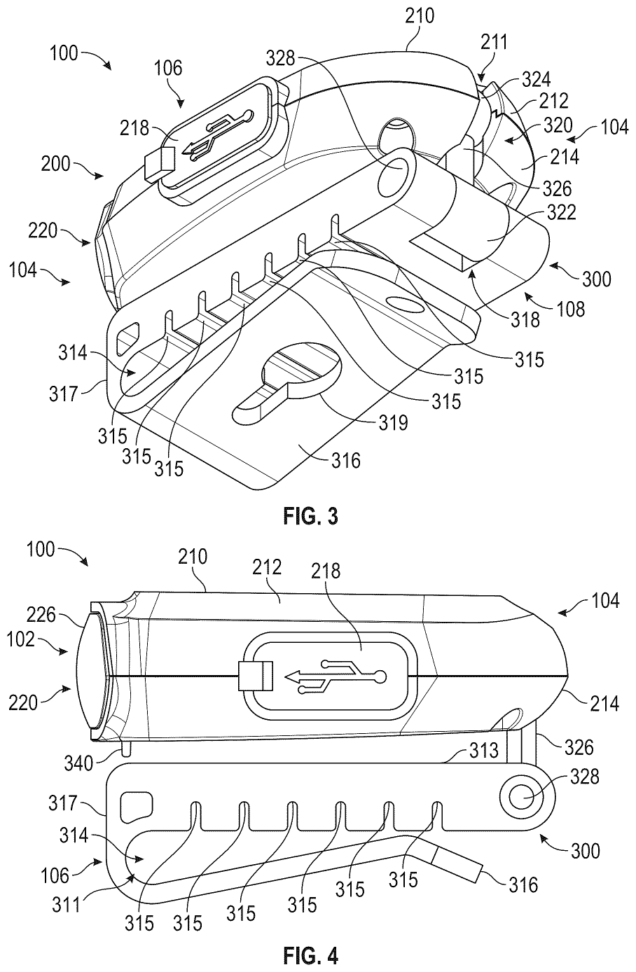

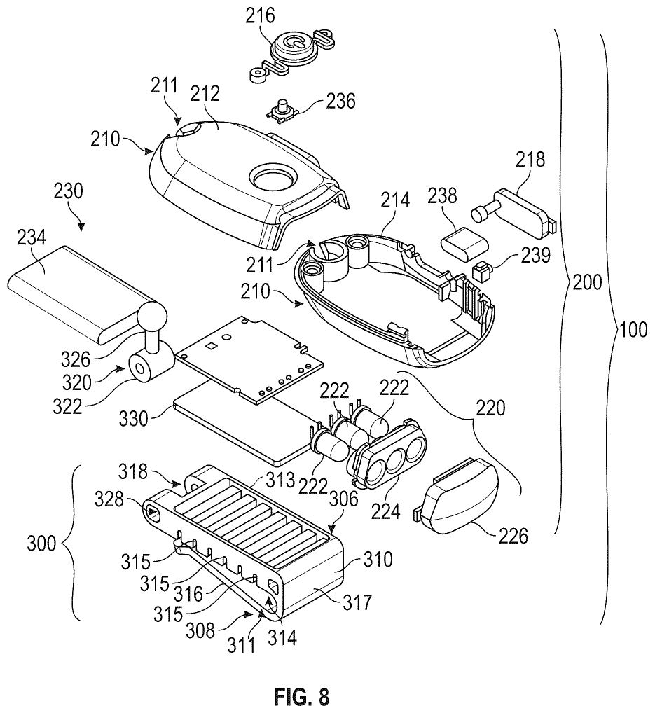

As seen in FIG. 3, the front 102 of the illumination assembly 200 includes a protective lens 226. At least one light source 222 (e.g., as shown in FIGS. 7 and 8) is positioned within the illumination housing 210 behind the protective lens 226. While three light sources 222 are shown in FIG. 8, it is understood that any number of light sources can be used to achieve a desired brightness (e.g., 50 to 500 lumens) or beam pattern. In some implementations, the light sources 222 include one or more light emitting diodes (LEDs). For example, the light sources 222 can include surface mount device (SMD) LEDs, chip-on-board (COB) LEDs, or other semiconductor-based light sources. Furthermore, the LEDs may be configured to emit light in various spectra, including white light of different color temperatures, red light, ultraviolet (UV) light, or infrared (IR) light. The inclusion of COB LEDs may facilitate a high density of light sources in a compact footprint, which can result in a more uniform light output and improved thermal management. The front 102 further has the protective lens 226 and/or a lens assembly 224 (e.g., TIR lenses, reflectors, or collimators). These elements protect the light sources 222 and focus or diffuse the emitted light into a narrow spot beam or a wide flood beam.

Control of the illumination assembly 200 is provided via a user interface 216. In the illustrated embodiment, the user interface 216 is a power button located on a side 106 of the housing. In various embodiments, the user interface 216 comprises at least one of a physical button, a capacitive touch sensor, a toggle switch, or a rotary dial. The user interface 216 can have a rubberized or silicone cover to prevent ingress of contaminants. The user interface 216 can be configured to toggle power and cycle through a collection of operational modes in response to successive actuations of the user interface 216. For instance, the light can cycle between a “high” mode for distance viewing, a “low” mode for reading, and a “red light” mode for maintaining night vision. In some implementations, the electronics assembly 230 can detect predetermined actuation patterns, such as a long press or a sequence of rapid presses, to activate specific operational modes (e.g., a strobe mode or an SOS pattern).

The illumination assembly 200 includes a charge port cover 218. This cover 218 protects an internal charging port 238 (e.g., USB-C or micro-USB) used to replenish an internal rechargeable battery 234. The electronics assembly 230, housed within the illumination assembly 200, includes a printed circuit board (PCB) 232, the rechargeable battery 234, and a switch 236. The PCB 232 includes the circuitry necessary for controlling illumination modes, managing power distribution, and charging the battery 234. In some examples, the PCB 232 includes fixed resistors, variable resistors, capacitors, inductors, diodes, or other similar electronic components.

The housing 210 functions as a retaining structure that fits the PCB 232 and positions the switch 236 properly to allow a user to interact with the user interface 216. When actuated, the user interface 216 acts upon a contact mechanism or an electronic sensing circuit of the switch 236. The depression of this contact mechanism forces it into contact with the PCB 232, which in turn changes the operational mode of the light sources 222. The internal rechargeable battery 234 provides the electrical energy necessary to power the light sources 222 and the associated electronics. The battery 234 can take many different forms depending on the desired power capacity, weight, and size constraints of the illumination housing 210. In one or more embodiments, the battery 234 is a lithium-based battery, such as a lithium-ion (Li-ion) or lithium-polymer (Li-Po) battery. In some implementations, the battery 234 can be configured to be replaceable. For example, the housing 210 can be at least partially openable to permit access to and replacement of the rechargeable battery 234.

In some embodiments, the operational mode of the portable lighting device 100 can further be controlled via external or environmental inputs. In some examples, the apparatus 100 has one or more sensors physically coupled to the housing 210, such as a motion sensor, a light sensor, a sound sensor (e.g., a microphone), or a heat sensor. The primary light sources 222 can be moved from an “off” mode to an “on” mode in response to an input signal from these sensors. For instance, the light sources 222 could turn on when a light sensor determines the apparatus 100 is in a dark environment, or in response to a user's voice or other noises. In one or more embodiments, the apparatus 100 can include a wireless transceiver (e.g., Bluetooth, NFC, or R.F.) that allows for control via a remote device, such as a cellular device (mobile device), an internet-enabled device, or an R.F. remote control. This allows a user to adjust settings or locate the apparatus 100 using a cell phone application.

The clip assembly 300 is configured to secure the apparatus 100 to a target object. The clip assembly 300 has a clip base 310 and a spring portion 316. The clip base 310 and the spring portion 316 are connected at a web 317. The clip assembly 300 has a clip top surface 306, a clip bottom surface 308, a clip front 102, and a clip rear 104. In some examples, the spring portion 316 can be bent slightly open relative to the clip base 310 at the web 317 to receive a mounting surface (such as a hat brim or a strap). Once the mounting surface is inserted between the spring portion 316 and the clip base 310, the spring portion 316 is allowed to relax, thereby securely gripping the mounting surface and holding the portable lighting device 100 in place via friction and clamping force.

In some embodiments, the clip base 310 has a collection of raised segments or studs 315. Additionally, a flex zone 314 (FIG. 1) can be located near the web 317. The flex zone 314 and raised portions 315 primarily function to allow the clip to conform to curved or non-planar surfaces, thereby increasing the contact area and making the attachment more secure.

The clip assembly 300 also includes an adhesive pad 330 (also referred to as an adhesive area) arranged on the clip top surface 306. The adhesive pad 330 can comprise a dry adhesive material such as a microsuction material or a nanosuction material. In some implementations, these materials act as “suction-cup” adhesives that rely on mechanical vacuum forces rather than chemical adhesives. For example, a microsuction or nanosuction material can comprise a flexible sheet (e.g., an acrylic foam, a silicone rubber, or a polyurethane elastomer) having a mounting surface populated with a high density of microscopic or nanoscopic gaps or crevices. When the mounting surface of the adhesive pad 330 is pressed against a flat, non-porous external surface (e.g., glass, polished metal, or finished plastic), the air within each crater is displaced, creating a localized vacuum that generates a strong suction force. Because this adhesion is mechanical rather than chemical, the adhesive pad 330 can be configured to leave no residue upon removal and can be repeatedly attached and detached. Over time, the accumulation of dust or debris in the gaps or crevices may reduce the effective suction force. In such implementations, the adhesive pad 330 is “renewable,” meaning that its adhesive properties can be restored by washing the mounting surface with water to remove contaminants and clear the gaps or crevices.

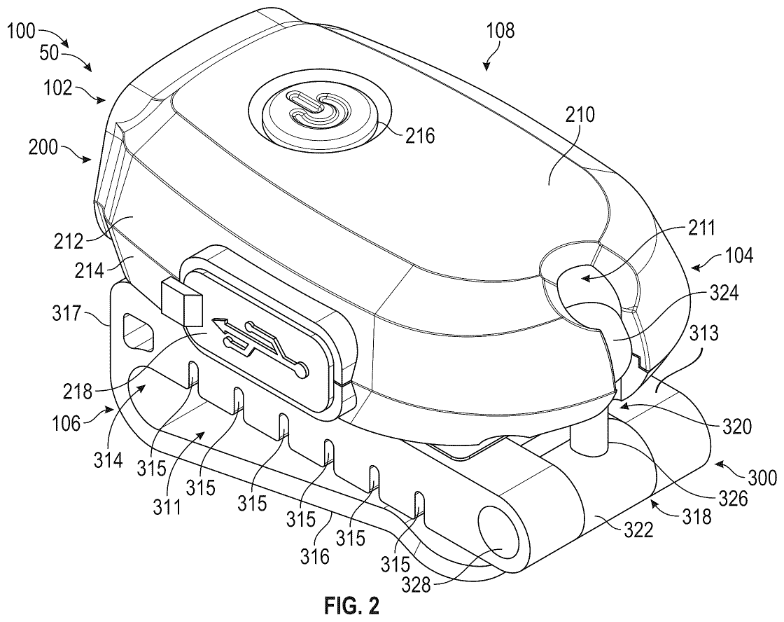

On the bottom portion 214, a standoff ridge 340 (best seen in FIG. 2 and FIG. 7) is provided. The standoff ridge 340 is a protrusion configured to prevent the bottom portion 214 from making direct contact with the clip assembly 300 when the apparatus 100 is in a folded configuration (e.g., a closed state). This air gap preserves the adhesive properties of the adhesive pad 330. Additionally, a securing loop 319 can be provided on the clip bottom surface 308 for hanging the apparatus 100 on a hook, tether, or other external support.

The illumination assembly 200 is moveably coupled to the clip assembly 300 via an articulation mechanism 320 (linkage). In one or more embodiments, the articulation mechanism 320 is configured as a solid body that functions as an intermediate mechanical link. The articulation mechanism 320 has a first end that interfaces with the illumination assembly 200 and a second end that interfaces with the clip assembly 300.

As a solid body, the articulation mechanism 320 has a hinge barrel 322 at the second end and a ball connector 324 at the first end. A pivot pin 326 extends from the hinge barrel 322 towards the illumination assembly 200 to establish a structural axis that extends through the articulation mechanism 320. The ball connector 324 is configured to interface with the illumination assembly 200 to form a ball-and-socket joint within the illumination assembly 200. Specifically, the rear portion 104 of the housing 210 of the illumination assembly 200 has a ball socket 211 that is sized and shaped to receive the ball connector 324, wherein the ball socket 211 is preferably located opposite the front portion 102 of the housing 210. The engagement between the ball connector 324 and the ball socket 211 creates a polyaxial joint that provides three degrees of freedom and enables a wide range of motion. Although not shown, the illumination assembly 200 and the hinge barrel 322 can be redesigned such that the pivot pin extends from the rear portion the rear 104 of the housing 210 of the illumination assembly 200 such that the ball connector is received within a ball connector formed within the hinge barrel 322.

At the clip interface, a hinge joint provides a first degree of freedom. Specifically, the clip rear 304 has a hinge recess 318 that is sized and shaped to receive the hinge barrel 322 of the articulation mechanism 320. A hinge pin 328 extends through the structural walls of the clip base 310 and through the hinge barrel 322. This hinged connection allows the articulation mechanism 320 to pivot about the longitudinal axis of the hinge pin 328. This motion provides a single degree of freedom characterized by a vertical pivot or “tilt” relative to the clip assembly 300.

The articulation mechanism 320 is an articulation linkage that provides at least four degrees of freedom and adjustability for positioning the illumination assembly 200 relative to the clip assembly 300, including pitch, yaw, and roll. Pitch allows the user to tilt the illumination assembly 200 up or down; yaw allows for swiveling the illumination assembly 200 left or right; and roll allows for rotating the illumination assembly 200 about its center axis. The non-cylindrical, flat geometry of the clip assembly 300 provides a stable base when the apparatus 100 is placed on a support surface for illumination of the nearby environment.

### B. Portable Lighting Device 1100

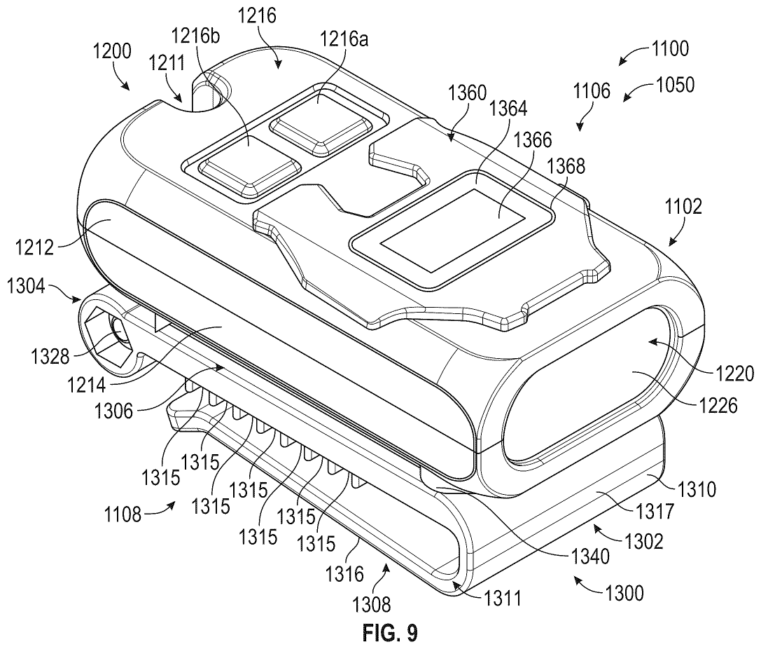

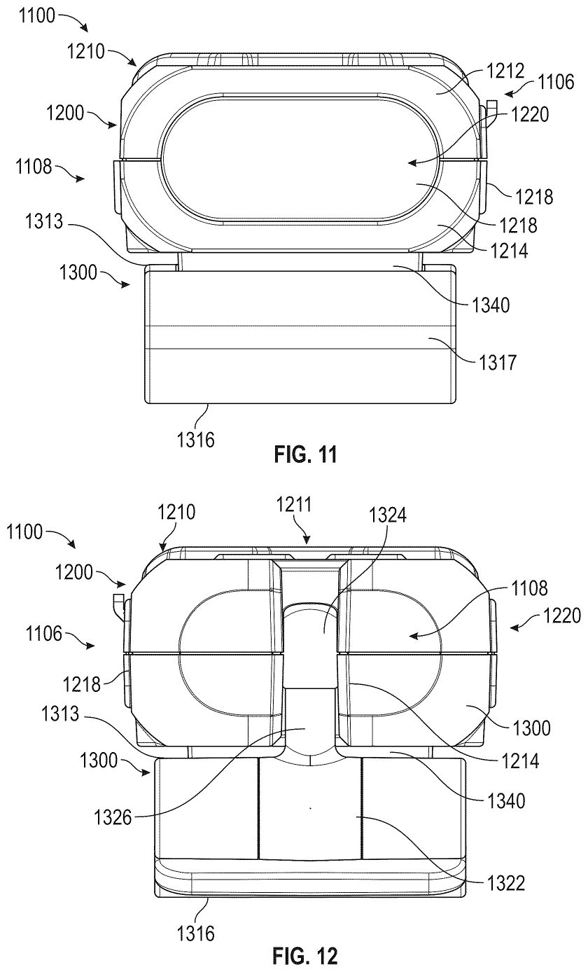

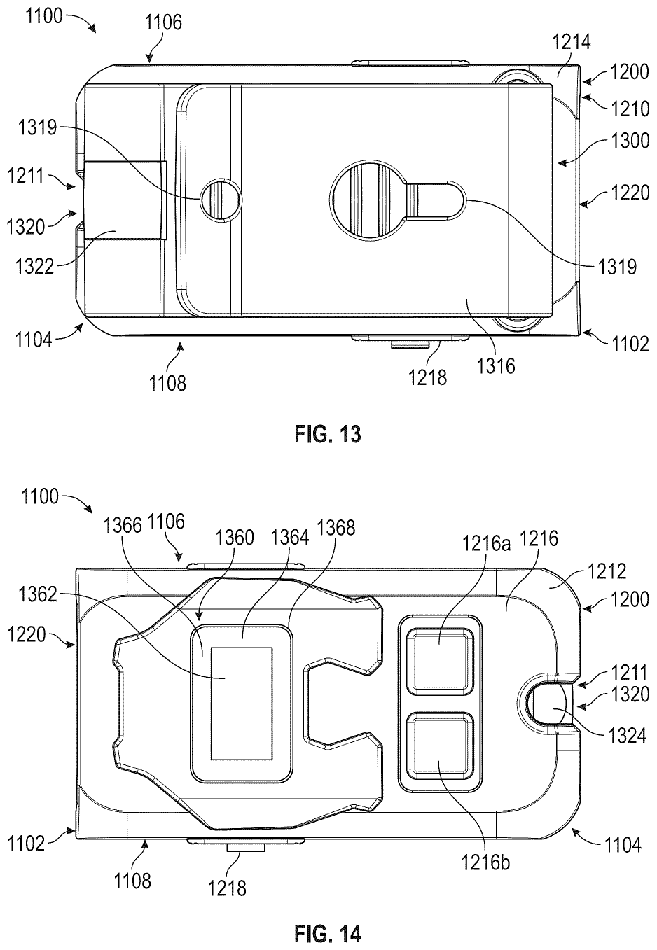

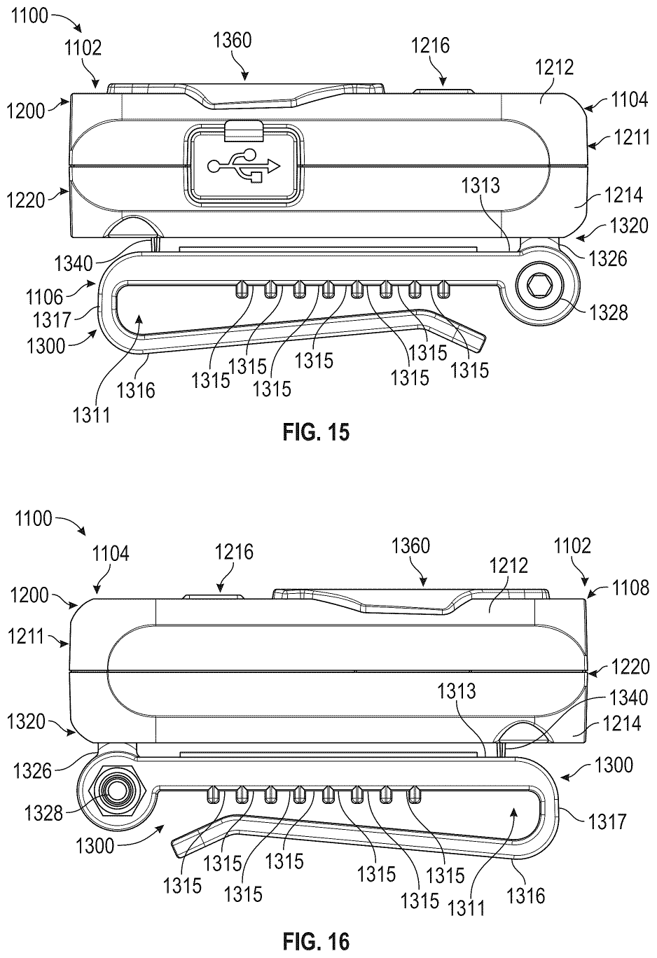

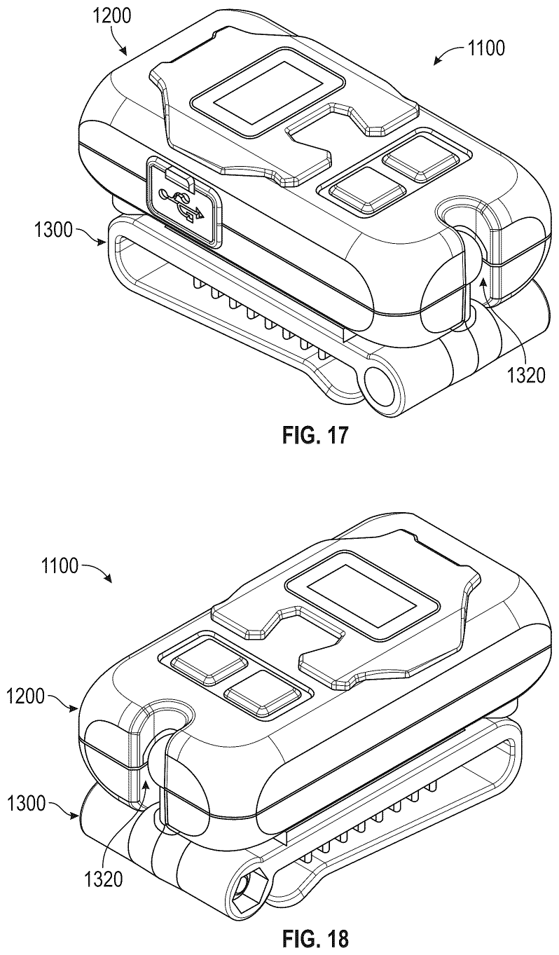

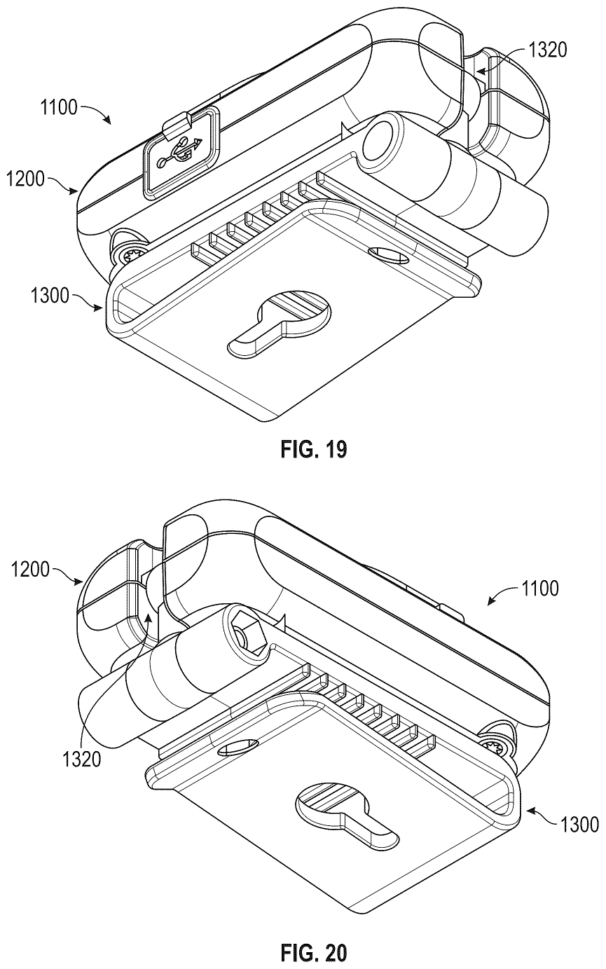

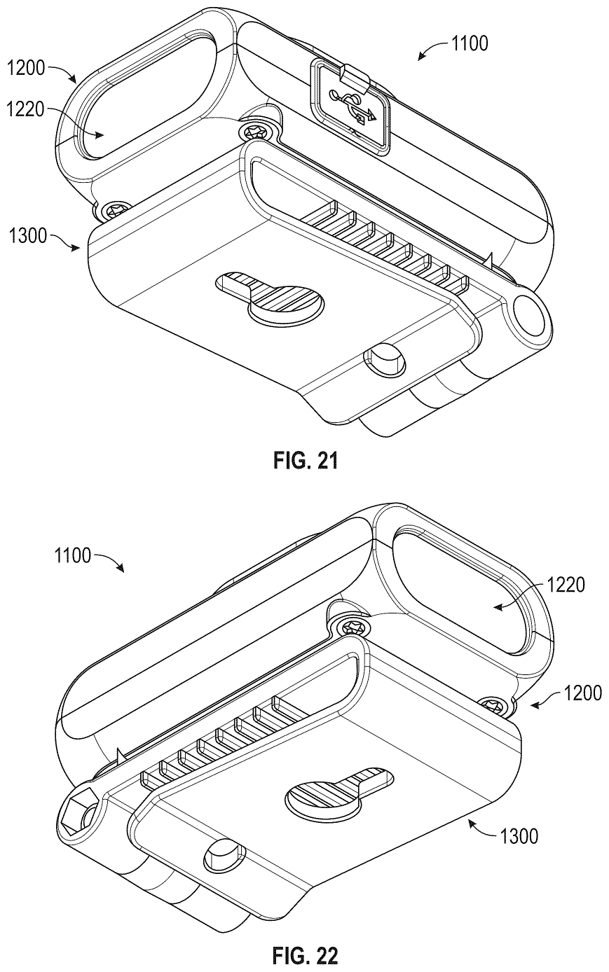

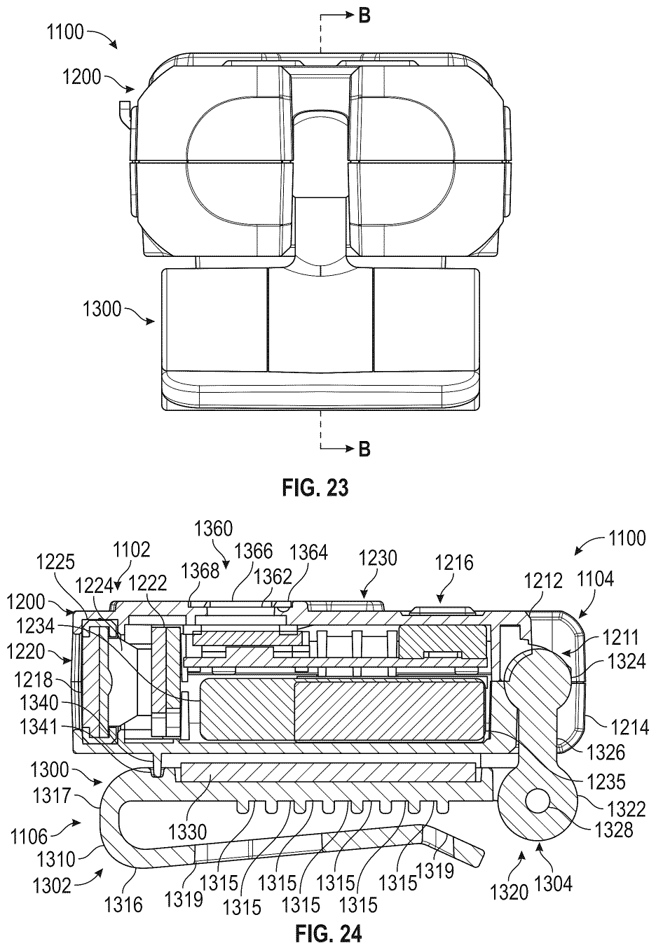

FIGS. 9-25 and 24 show a portable lighting device 1100 configured as an clip light apparatus 1050 (e.g., a portable lighting apparatus, a flashlight) is illustrated according to a second embodiment. The portable lighting device 1100 generally has an illumination assembly 1200 and a clip assembly 1300. The illumination assembly 1200 and the clip assembly 1300 are moveably coupled to one another by an articulation mechanism 1320, which is also referred to as an articulation linkage. This configuration allows for the adjustable orientation of light output relative to an object (e.g., a hat 2600, a backpack strap, or a work surface) to which the apparatus 1100 is secured. As discussed below, the clip assembly 1300 has a U-shaped receiver 1311 that receives an object to support the portable lighting device 1100, however, the clip assembly 1300 can be modified to remove the receiver 1311 such that the clip assembly 300 includes a planar support member 1313.

The various structural components of the portable lighting device 1100 can be constructed from a variety of durable materials. For example, these components can include molded plastics (e.g., ABS, polycarbonate, or polypropylene), metals (e.g., aluminum, titanium, or stainless steel), composite materials (e.g., carbon fiber), or combinations thereof. In some examples, the housing portions can be over-molded with a thermoplastic elastomer (TPE) to improve grip and impact resistance. Additionally, the second embodiment of the portable lighting device 1100 includes advanced seals and other appropriate components to enable the apparatus 1100 to have an Ingress Protection (IP) rating (e.g., IPX4, IP54, IP67) or other form of environmental protection to provide resistance against moisture, dust, and debris.

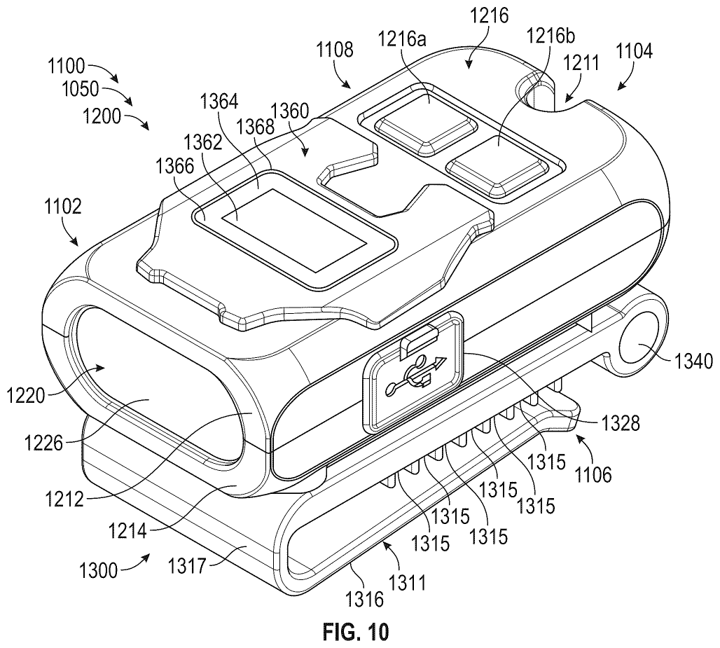

The illumination assembly 1200 (also referred to as a light portion) has an illumination housing 1210 that contains an internal illuminator 1220 and an electronics assembly 1230. The illuminator 1220 is an electro-optical circuit and lensing assembly configured to generate and direct light. In one or more embodiments, the housing 1210 has an upper housing portion 1212 and a bottom portion 1214. These portions can be secured via fasteners 1350, ultrasonic welding, or snap-fit features. As seen in FIG. 10, the housing 1210 defines a front 1102, a back 1104, and lateral sides 1106, 1108. In some embodiments, the housing 1210 may be designed to meet or exceed waterproof standards (i.e., ip67 or ip68) for flashlights and/or designed to float in water.

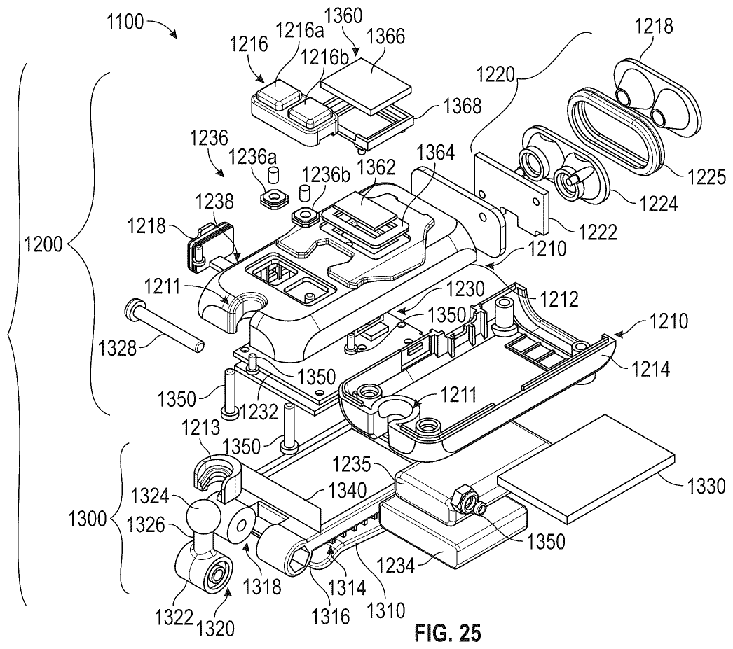

As seen in FIG. 11, the front 1102 of the illumination assembly 1200 includes a protective lens 1226. At least one light source 1222 (e.g., as shown in FIGS. 24 and 25) is positioned within the illumination housing 1210 behind the protective lens 1226. In some implementations, the light sources 1222 include one or more light emitting diodes (LEDs). Furthermore, the LEDs may be configured to emit light in various spectra, including white light of different color temperatures, red light, ultraviolet (UV) light, or infrared (IR) light. In some embodiments, the illumination assembly 1200 can include a laser emitter that can be activated through the user interface 1216. The inclusion of COB LEDs may facilitate a high density of light sources in a compact footprint, which can result in a more uniform light output and improved thermal management. The front 1102 further has the protective lens 1226 and/or a lens assembly 1224 (e.g., TIR lenses, reflectors, or collimators). These elements protect the light sources 1222 and focus or diffuse the emitted light into a narrow spot beam or a wide flood beam.

As best seen in the sectional view of FIG. 24, the internal configuration of the illumination assembly 1200 includes a secondary illuminator assembly 1360 having a secondary illuminator 1362 positioned separately from the primary illumination assembly 1220. The secondary illuminator 1362 can include an LED or an electroluminescent (EL) panel light for specialized illumination tasks. In some implementations, the housing 1210 includes advanced sealing features to improve durability. A first seal 1225 is provided at the interface between the housing and the illuminator components. An internal lens 1366 is secured within the housing by a retainer 1368. Furthermore, a second seal 1364 is positioned within the assembly to prevent ingress of moisture or dust. As shown in FIG. 24, the retainer 1368 can be configured to exert a compressive force against the internal lens 1366, which in turn seats against the second seal 1364 to form a hermetic barrier for the internal illuminator 1220. The first seal 1225 can be positioned at a periphery of the lens assembly 1224 to prevent moisture from entering an interstitial space between the upper housing portion 1212 and the electronics assembly 1230.

Control of the illumination assembly 1200 is provided via a user interface 1216. In various embodiments, the user interface 1216 comprises at least one of a physical button, a capacitive touch sensor, a toggle switch, or a rotary dial. In the illustrated embodiment, the user interface includes first and second buttons 1216a, 1216b and a corresponding switch assembly 1236 having internal switches 1236a, 1236b. For example, button 1216a can control the primary light sources 1222, while button 1216b can independently control the secondary illuminator 1362. The PCB 1232 can define distinct electrical pathways for the light sources 1222 and the secondary illuminator 1362. This hardware-level separation allows for simultaneous illumination or the selection of specific light spectra without cycling through a single-button control sequence. The user interface 1216 can be configured to toggle power and cycle through a collection of operational modes in response to successive actuations of the user interface 1216. For example, each actuation can cause the apparatus 1100 to step sequentially through a cycle of modes. In another example, the electronics assembly 1230 can detect predetermined actuation patterns, such as a long press or a sequence of rapid presses, to activate specific operational modes (e.g., a “strobe” mode or a “night vision” red light mode).

The illumination assembly 1200 includes a charge port cover 1218. This cover 1218 protects an internal charging port 1238 (e.g., USB-C or micro-USB) used to replenish an internal rechargeable power source 1234. The electronics assembly 1230, housed within the illumination assembly 1200, includes a printed circuit board (PCB) 1232, the power source 1234, and the switches 1236a, 1236b. The PCB 1232 includes the circuitry necessary for controlling illumination modes, managing power distribution, and charging the power source 1234. In some examples, the PCB 1232 includes fixed resistors, variable resistors, capacitors, inductors, diodes, or other similar electronic components.

The housing 1210 functions as a retaining structure that fits the PCB 1232 and positions the switches properly to allow a user to interact with the user interface buttons 1216a, 1216b. When actuated, the user interface acts upon a contact mechanism or an electronic sensing circuit of the switches 1236a, 1236b. The depression of this contact mechanism forces it into contact with the PCB 1232, which in turn changes the operational mode of the light sources 1222 or 1362.

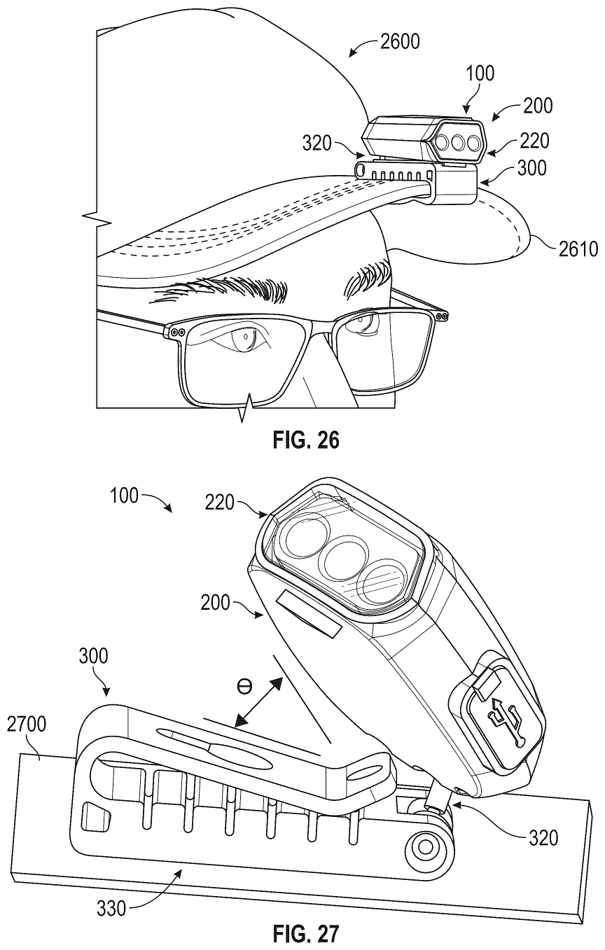

The internal power source 1234 provides the electrical energy necessary to power the light sources and associated electronics. In some examples, a secondary battery 1235 can be included to provide redundant power or to power the secondary illuminator 1362 independently. In one or more embodiments, the power sources 1234, 1235 are lithium-based batteries, such as a lithium-ion (Li-ion) or lithium-polymer (Li-Po) battery. In some implementations, the power source 1234 can be configured to be replaceable. For example, the housing 1210 can be at least partially openable to permit access to and replacement of the battery. In some examples, the housing 1210 may include a removable portion, such as a panel, door, or cover, that can be transitioned between a closed position and an open position to expose an internal battery compartment. As seen in FIGS. 26-30, the housing 1210 can be configured to permit rapid replacement of the power source 1234/1235 via access panels secured by fasteners 1350 or sliding latches.

In some embodiments, the operational mode of the portable lighting device 1100 can further be controlled via external or environmental inputs. In some examples, the apparatus 1100 has one or more sensors physically coupled to the housing 1210, such as a motion sensor, a light sensor, a sound sensor (e.g., a microphone), or a heat sensor. The light sources 1222 can be moved from an “off” mode to an “on” mode in response to an input signal from these sensors. For instance, the light sources 1222 could turn on when a light sensor determines the apparatus 1100 is in a dark environment, or in response to a user's voice or other noises. In another example, the light sources can activate when a motion sensor detects movement, such as a user moving their hand to find the apparatus 1100 in the dark.

In one or more embodiments, the apparatus 1100 can include a wireless transceiver (e.g., Bluetooth, NFC, or R.F.) that allows for control via a remote device, such as a cellular device (mobile device), an internet-enabled device, or an R.F. remote control. This allows a user to adjust settings or locate the apparatus 1100 using a cell phone application.

The clip assembly 1300 is configured to secure the apparatus 1100 to a target object. The clip assembly 1300 has a clip base 1310 and a spring portion 1316. The clip base 1310 and the spring portion 1316 are connected at a web 1317. The clip assembly 1300 has a clip top surface 1306, a clip bottom surface 1308, a clip front 1302, and a clip rear 1304. In some examples, the spring portion 1316 can be bent slightly open relative to the clip base 1310 at the web 1317 to receive a mounting surface (such as the brim 2610 of a hat 2600). Once the mounting surface is inserted between the spring portion 1316 and the clip base 1310, the spring portion 1316 is allowed to relax, thereby securely gripping the mounting surface and holding the portable lighting device 1100 in place via friction and clamping force.

In some embodiments, the clip base 1310 has a collection of raised segments or studs 1315. Additionally, a flex zone 1314 (FIG. 9) can be located near the web 1317. The flex zone 1314 and raised segments 1315 primarily function to allow the clip to conform to curved or non-planar surfaces, thereby increasing the contact area and making the attachment more secure.

The clip assembly 1300 also includes an adhesive pad 1330 arranged on the clip top surface 1306. The adhesive pad 1330 (also referred to as an adhesive area) can comprise a dry adhesive material such as a microsuction material or a nanosuction material. In some implementations, these materials act as “suction-cup” adhesives that rely on mechanical vacuum forces rather than chemical adhesives. For example, a microsuction or nanosuction material can comprise a flexible sheet (e.g., an acrylic foam, a silicone rubber, or a polyurethane elastomer) having a mounting surface populated with a high density of microscopic or nanoscopic gaps or crevices. In some examples, there may be thousands or millions of such gaps or crevices per square inch. When the mounting surface of the adhesive pad 1330 is pressed against a flat, non-porous external surface (e.g., glass, polished metal, or finished plastic), the air within each crater is displaced, creating a localized vacuum that generates a strong suction force. Because this adhesion is mechanical rather than chemical, the adhesive pad 1330 can be configured to leave no residue upon removal and can be repeatedly attached and detached.

In some implementations, the microsuction or nanosuction materials are bio-inspired, mimicking the hierarchical structures found on the toe pads of geckos to utilize Van der Waals forces in addition to or in place of vacuum suction. The adhesive pad 1330 can be constructed from materials such as those provided under the trade names Setex®, GekkoStick®, or similar synthetic “gecko” or dry adhesive products. Over time, the accumulation of dust or debris in the gaps or crevices may reduce the effective suction force. In such implementations, the adhesive pad 1330 is “renewable,” meaning that its adhesive properties can be substantially restored by washing the mounting surface with water or a mild detergent to remove contaminants and clear the gaps or crevices.

On the bottom portion 1214, a standoff ridge 1340 (best seen in FIG. 11) is provided. The standoff ridge 1340 is configured to matingly engage with or be received in a channel 1341 defined in the clip assembly when the apparatus 1100 is in a folded configuration (e.g., closed state). The standoff ridge 1340 is a protrusion configured to prevent the bottom portion 1214 from making direct contact with the clip assembly 1300 when the apparatus 1100 is in the folded configuration. This air gap preserves the adhesive properties of the adhesive pad 1330. Additionally, a securing loop 1319 can be provided on the clip bottom surface 1308 for hanging the apparatus 1100.

The illumination assembly 1200 is moveably coupled to the clip assembly 1300 via an articulation mechanism 1320 (linkage). In one or more embodiments, the articulation mechanism 1320 is configured as a solid body that functions as an intermediate mechanical link. The articulation mechanism 1320 has a first end that interfaces with the illumination assembly 1200 and a second end that interfaces with the clip assembly 1300.

As a solid body, the articulation mechanism 1320 has a hinge barrel 1322 at the second end and a ball connector 1324 at the first end. A pivot pin 1326 extends from the hinge barrel 1322 towards the illumination assembly 1200 to establish a structural axis that extends through the articulation mechanism 1320. The ball connector 1324 is configured to interface with the illumination assembly 1200 to form a ball-and-socket joint within the illumination assembly 1200. Specifically, the rear portion 1104 of the housing 1210 of the illumination assembly 1200 has a ball socket 1211 that is sized and shaped to receive the ball connector 1324, wherein the ball socket 1211 is preferably located opposite the front portion 1102 of the housing 1210. To improve the precision of the articulation mechanism, a friction cup 1213 is seated within the ball socket 1211. The friction cup 1213 is configured to grip the ball connector 1324 with a predetermined amount of tension, thereby providing a “feel” of resistance that prevents the illumination assembly 1200 from moving inadvertently. Although not shown, the illumination assembly 1200 and the hinge barrel 1322 can be redesigned such that the pivot pin extends from the rear portion the rear 1104 of the housing 1210 of the illumination assembly 1200 such that the ball connector is received within a ball connector formed within the hinge barrel 1322.

At the clip interface, a hinge joint provides a first degree of freedom. Specifically, the clip rear 1304 has a hinge recess 1318 that is sized and shaped to receive the hinge barrel 1322 of the articulation mechanism 1320. A hinge pin 1328 extends through the structural walls of the clip base 1310 and through the hinge barrel 1322. This hinged connection allows the articulation mechanism 1320 to pivot about the longitudinal axis of the hinge pin 1328. This motion provides a single degree of freedom characterized by a vertical pivot or “tilt” relative to the clip assembly 1300.

The articulation mechanism 1320 is an articulation mechanism (or articulation linkage) that provides at least four degrees of freedom and adjustability for positioning the illumination assembly 1200 relative to the clip assembly 1300, including pitch, yaw, and roll. Pitch allows the user to tilt the illumination assembly 1200 up or down; yaw allows for swiveling the illumination assembly 1200 left or right; and roll allows for rotating the illumination assembly 1200 about its center axis. The non-cylindrical, flat geometry of the clip assembly 1300 provides a stable base when the apparatus 1100 is placed on a support surface for illumination of the nearby environment.

### C. Usage of the Portable Lighting Devices 50, 1050

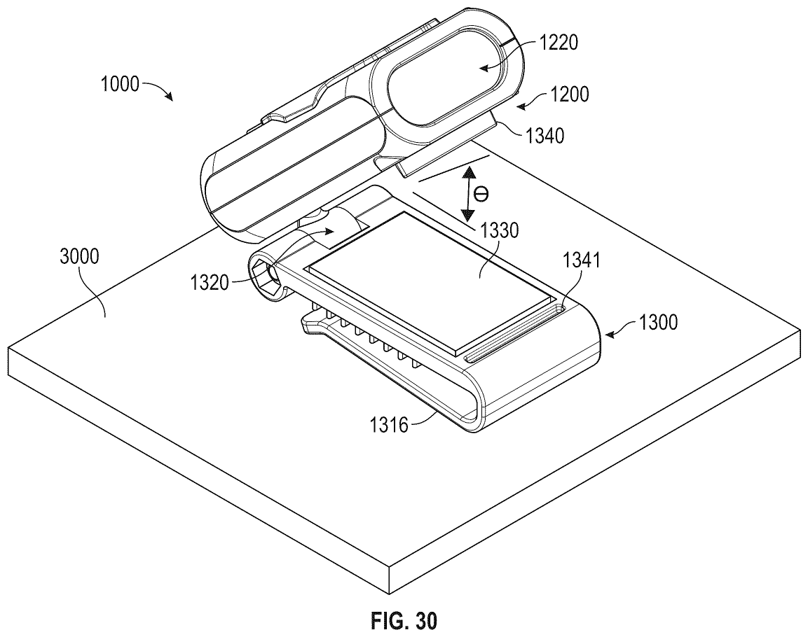

Referring to FIGS. 26-30, various implementations and use cases of the portable lighting devices 100 and 1100 are illustrated. These Figures demonstrate the versatility of the devices 100, 1100 in different operating environments and the various ways the illumination assemblies 200, 1200 may be oriented relative to a mounting surface or object to solve specific directional lighting challenges. Although FIGS. 26-29 show usage of the first embodiment of the portable lighting device 100, it is understood that the second embodiment of the portable lighting device 1100 can be positioned and used in the same manner shown in those Figures. The same relationship applies to FIG. 30, which shows usage of the second embodiment of the portable lighting device 1100 instead of the first embodiment of the portable lighting device 100).

As illustrated in FIG. 26, the portable lighting device 100 is shown in a use case where the clip assembly 300 is secured to a brim 2610 of a hat 2600. In the illustrated example, the brim 2610 is inserted into the receiver 311 and gripped by the spring force of the clip assembly 300 to prevent the portable lighting device 100 from inadvertently being dislodged during movement. This configuration positions the apparatus 100 in a convenient location that illuminates the area directly in front of the wearer's gaze, which is particularly useful for hands-free tasks such as mechanical repair, reading, or navigating difficult terrain at night. Utilizing the articulation mechanism, the illumination assembly 200 may be rotated and tilted through the four degrees of freedom provided by the articulation mechanism 320 and the ball-and-socket joint. This allows the light output to be aimed precisely toward a target within the wearer's field of vision, effectively compensating for the downward or upward tilt of the brim 2610. The example apparatus 1100 can be used in a similar way, providing the same gaze-aligned illumination benefits.

FIG. 27 illustrates the apparatus 100 resting on a substantially flat surface 2700. In this example, the clip assembly 300 may or may not include the adhesive pad 330; for instance, the apparatus 100 can simply rest on the surface 2700 under the force of gravity. When resting on a horizontal surface 2700, the wide, non-cylindrical geometry of the clip assembly 300 provides a stable, non-rolling base that overcomes the positioning constraints common in standard cylindrical flashlights. The articulation mechanism 320 may be pivoted upward to elevate the illumination assembly 200 an operating angle θ to the surface 2700, while the ball-and-socket joint permits polyaxial aiming to illuminate specific work areas from a stationary position. This “lantern mode” provides a reliable light source for tabletops or workbenches where a clippable mounting point is unavailable. It is understood that the example portable lighting device 1100 is equally capable of being utilized in this stationary manner.

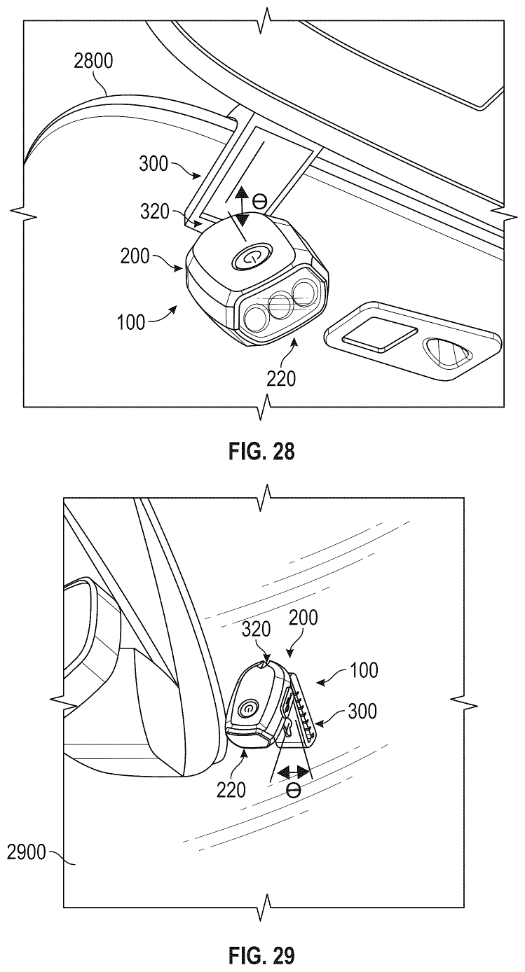

As illustrated in FIG. 28, the apparatus 100 is shown clipped to an automotive sun visor 2800, where an extent of the sun visor is into the receiver 311 In this orientation, the clip assembly 300 secures the apparatus 100 to the sun visor 2800, where the spring portion 316 and clip base 310 exert a consistent clamping force that withstands typical vehicle vibrations. The polyaxial joint allows the illumination assembly 200 to be oriented at an operating angle θ to the visor to provide specialized task lighting—such as for map reading or illuminating vehicle controls—overcoming the fixed and often inadequate orientation of typical built-in automotive cabin lights. This directional control ensures that light can be focused on a passenger's workspace without creating distracting glare for the driver. The example apparatus 1100 can be used in a similar way to enhance interior vehicle visibility.

As illustrated in FIG. 29, the apparatus 100 is shown removably affixed to an automobile windshield 2900. In this implementation, the adhesive pad 330 (e.g., comprising the nanosuction or microsuction material described above) is utilized to secure the apparatus 100 directly to the glass support surface of the windshield 2900. In this configuration, the articulation mechanism 320 is moved to an open configuration or extended position to fully expose the adhesive pad 330 for maximum contact with the support surface 2900. The polyaxial joint then allows the light portion to be aimed away from the glass surface to provide an operating angle θ to the windshield for illumination purposes, thereby providing versatile interior illumination that is not dependent on a clippable edge. This secondary attachment mode represents a significant technical advantage in environments consisting primarily of planar surfaces, such as windows, glass, mirrors, or dashboards. The example apparatus 1100 can be used in a similar way.

As illustrated in FIG. 30, the apparatus 1100 is shown resting on a substantially flat, planar surface 3000 in an inverted base configuration, where the apparatus is oriented at an operating angle θ to the support surface for illumination purposes. Similar to the implementation shown in FIG. 27, the apparatus 1100 may be supported by the surface 3000 via gravity. In the illustrated example, the clip assembly 1300 has been configured relative to the illumination assembly 1200 such that the adhesive pad 1330 is oriented away from the surface 3000, and the spring portion 1316 provides the lowermost points of contact with the surface 3000. This inverted orientation effectively shields the adhesive pad 1330 from potential contaminants, moisture, or damage that might be present on a “hostile” or unprepared surface. Despite the inverted orientation of the base, the articulation mechanism 1320 and the polyaxial ball-and-socket joint remain fully operable to set the height and operating angle θ of the illumination assembly 1200. This ensures that the functional utility of the apparatus 1100, e.g., precise directional lighting, is maintained even when the user chooses to protect the primary adhesive surface. The example apparatus 100 can be positioned and used in a similar way.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

It is to be understood that the apparatus disclosed herein are not limited to the exact details of construction, operation, exact materials, or embodiments shown and described, as obvious modifications and equivalents will be apparent to one skilled in the art. While the specific embodiments have been illustrated and described, numerous modifications come to mind without significantly departing from the spirit of the disclosure, and the scope of protection is only limited by the scope of the accompanying Claims. Preferred embodiments of this disclosure are described herein, including the best mode known to the inventors for carrying out the disclosure. It should be understood that the illustrated embodiments are exemplary only, and should not be taken as limiting the scope of the disclosure. It should also be understood that substantially utilized herein means a deviation that is less than 15% and preferably less than 5%. It should also be understood that other configuration or arrangements of the above-described components is contemplated by this Application.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A portable lighting device comprising:
a clip assembly configured to secure the portable lighting device to an object;
an illumination assembly comprising a housing, at least one light source residing within the housing, a power source residing within the housing and at least one interface that is operably connected to the power source and the at least one light source; and
an articulation mechanism having a first end moveably coupled to the illumination assembly and a second end moveably coupled to the clip assembly, wherein the articulation mechanism is configured to provide at least four degrees of freedom and adjustability between the clip assembly and the illumination assembly.

2. The portable lighting device of claim 1, wherein the first end of the articulation mechanism is pivotally coupled to one of the clip assembly or the illumination assembly at a hinge joint to provide at least one degree of freedom of movement.

3. The portable lighting device of claim 1, wherein the second end of the articulation mechanism is polyaxially coupled to one of the clip assembly or the illumination assembly at a ball-and-socket joint to provide three degrees of freedom of movement.

4. The portable lighting device of claim 3, wherein the ball-and-socket joint comprises:
a ball connector disposed at the first end or the second end of the articulation mechanism;
a ball socket defined in the housing of the illumination assembly or the clip assembly; and
a friction cup seated within the ball socket and configured to exert a predetermined tension on the ball connector to resist inadvertent movement of the ball connector within the ball socket.

5. The portable lighting device of claim 1, further comprising an adhesive pad disposed on a surface of the clip assembly.

6. The portable lighting device of claim 5, wherein the adhesive pad is formed of a microsuction material or a nanosuction material.

7. The portable lighting device of claim 5, wherein the illumination housing comprises a ridge that is received within a channel of the clip assembly to form a standoff between the clip assembly and the illumination housing whereby the illumination housing is prevented from contacting the adhesive pad when the portable lighting device is in a folded configuration.

8. The portable lighting device of claim 1, wherein the clip assembly comprises a clip base and a spring portion connected at a web, the clip base further comprising at least one flex zone configured to allow the clip base to conform to a surface.

9. The portable lighting device of claim 1, wherein the at least one light source comprises at least one light emitting diode (LED).

10. The portable lighting device of claim 1, wherein the power source is a rechargeable battery.

11. The portable lighting device of claim 1, wherein the illumination assembly further comprises a secondary illuminator independently controllable from the at least one light source.

12. The portable lighting device of claim 11, wherein the secondary illuminator comprises an LED light or an electroluminescent (EL) panel light.

13. The portable lighting device of claim 1, wherein the housing of the illumination assembly includes at least one seal configured to provide environmental protection for an internal electronic assembly within the housing of the illumination assembly.

14. The portable lighting device of claim 1, wherein the housing further comprises a protective lens, and the illumination assembly further comprises an internal lens positioned behind the protective lens.

15. The portable lighting device of claim 1, wherein the articulation mechanism is a solid body comprising a hinge barrel at a first end of the solid body and a ball connector at a second end of the solid body opposite the first end, the hinge barrel being secured to the clip assembly by a hinge pin.

16. The portable lighting device of claim 1, wherein the illumination assembly comprises a user interface comprising at least one of a physical button, a capacitive touch sensor, a toggle switch, or a rotary dial.

17. The portable lighting device of claim 16, wherein the illumination assembly comprises an electronics assembly configured to cycle the at least one light source through a plurality of operational modes in response to successive actuations of the user interface.

18. The portable lighting device of claim 17, wherein the electronics assembly is configured to detect a predetermined actuation pattern of the user interface to activate a specific operational mode, the predetermined actuation pattern comprising at least one of a long press or a sequence of rapid presses of the user interface.

19. A portable lighting device with multiple degrees of freedom and adjustability, the lighting device comprising:
a clip assembly configured to secure the portable lighting device to an object, the clip assembly having a U-shaped configuration provided by an upper member, a lower member and a curvilinear portion extending between the upper and lower members, the clip assembly also having an adhesive pad disposed on an outer surface of the upper member;
an illumination assembly comprising a housing, at least one light source residing within the housing, a power source residing within the housing and at least one interface that is operably connected to the power source and the at least one light source; and
an articulation mechanism having a first end moveably coupled to the illumination assembly and a second end moveably coupled to the clip assembly, wherein the articulation mechanism is configured to provide at least four degrees of freedom between the clip assembly and the illumination assembly.

20. The portable lighting device of claim 19, wherein the housing of the illumination assembly includes a ridge that depends downward from the housing and that is received within a channel of the clip assembly when the portable lighting device is in a folded configuration.

21. The portable lighting device of claim 20, wherein reception of the ridge within the channel forms a standoff between the clip assembly and the housing of the illumination assembly whereby the housing is prevented from contacting the adhesive pad.

22. The portable lighting device of claim 21, wherein the illumination assembly is pivoted about clip assembly via the articulation mechanism whereby the housing moves away from and exposes the adhesive pad such that the portable lighting device can be affixed by the adhesive pad to a support surface.

23. The portable lighting device of claim 19, wherein the first end of the articulation mechanism is polyaxially coupled to the illumination assembly at a ball-and-socket joint, and wherein the second end of the articulation mechanism is pivotally coupled to the clip assembly at a hinge joint.
